(19) United States
(12) Patent Application Publication
(10) Pub. No.: US 2010/0035116 A1
(43) Pub. Date: Feb. 11, 2010

(54) FLUOROPOLYMER/EVOH/PPA MULTILAYER PIPE FOR CONVEYING HYDROGEN AND A FUEL CELL ELECTRICITY PRODUCTION ASSEMBLY INCLUDING SUCH A PIPE

(76) Inventor: Cyrielle Cheng, Saint-Jean de Monts (FR)

Correspondence Address: Muncy, Geissler, Olds & Lowe, PLLC, P.O. BOX 1364, FAIRFAX, VA, 22038-1364, US

(21) Appl. No.: 12/444,768

(22) PCT Filed: Oct. 4, 2007
(86) PCT No.: PCT/FR2007/001620

§ 371 Date: Apr. 8, 2009

(30) Foreign Application Priority Data
Oct. 9, 2006 (FR) 0608827

(51) Int. Cl. H01M 2/00; F16L 11/04; F16L 11/20

(52) U.S. Cl. 429/34; 138/137

(57) ABSTRACT

A pipe having: a layer of fluoropolymer; an intermediate layer of ethylene and vinyl alcohol copolymer; and an outer layer of polyphthalamide. An electricity production assembly is provided using a fuel cell and including such a pipe.

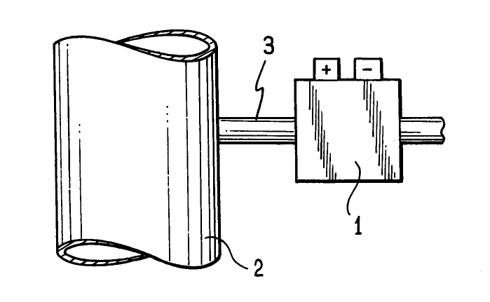

The present invention relates to a multilayer pipe suitable for conveying hydrocarbons or fuel, and more particularly hydrogen feeding a fuel cell. The invention also relates to an electricity production assembly having a fuel cell including such a pipe.

### BACKGROUND OF THE INVENTION

For the purpose of conveying hydrogen to a fuel cell, proposals have been made to use pipes of the same kind as those used for conveying hydrocarbon fuels. Nevertheless, given the small size of hydrogen molecules, more particularly molecules in the form of dihydrogen (H₂), they diffuse through pipe walls to a greater extent than do hydrocarbon molecules. Known pipes presenting the best performance for conveying hydrogen are pipes made of metal or of rubber. Unfortunately, most metal tubes are sensitive to corrosion and they present poor resistance to aging. Rubber pipes are very permeable to gas, and particles of matter coming from the pipe can become mixed with the fluid being conveyed and degrade the membranes present in the fuel cell. Furthermore, both of those two types of pipe are fairly inflexible, rather bulky, and expensive.

### OBJECT OF THE INVENTION

An object of the invention is to provide means enabling hydrogen to be conveyed while limiting or eliminating the above-specified drawbacks.

### SUMMARY OF THE INVENTION

To this end, the invention provides a pipe comprising, from the inside towards the outside: a layer of fluoropolymer; an intermediate layer of ethylene and vinyl alcohol copolymer; and an outer layer of polyphthalamide.

Each layer constitutes a barrier layer preventing molecules of dihydrogen migrating to the outside. The ethylene vinyl alcohol layer constitutes a barrier to molecules of dioxygen and to other molecules such as carbon dioxide or nitrogen oxides that might be mixed with the dihydrogen (but without being combined therewith). Polyphthalamide is a material presenting good resistance to hydrocarbons and to external attack, and presents good mechanical properties, in particular with respect to impacts and traction. The pipe also presents good temperature performance, enabling it to be used over a relatively large temperature range, of about −40° C. to 130° C.

According to advantageous characteristics, the fluoropolymer is of ethylene tetrafluoroethylene (ETFE) or an ethylene fluoroethylene perfluoride (EFEP).

Ethylene tetrafluoroethylene (ETFE) and ethylene fluoroethylene perfluoride (EFEP) present similar characteristics, and in particular they constitute barrier materials against hydrocarbons, alcohols, and gases (dihydrogen, dioxygen, nitrogen oxide, carbon dioxide, and sulfur dioxide, where said oxides constitute residues from extracting dihydrogen in the gaseous phase). These two materials also present good resistance to chemical degradation and to taking up moisture.

Advantageously, the layer of fluoropolymer is the innermost layer of the pipe.

The pipe then has a structure that is relatively simple, presenting good performance.

Also advantageously, the pipe has an inner layer of polyamide and/or a polyamide layer extending between the layer of ethylene and vinyl alcohol copolymer and the outer layer.

The use of polyamides serves to reinforce the impermeability of the pipe to dihydrogen and other gases. They also degrade little in contact with the fluid, thereby reducing the risk of contaminating the conveyed fluid with particles of polyamide. Finally, polyamide presents mechanical and chemical properties that ensure that the pipe presents good performance in the face of external attack. Polyamide also presents the advantage of being inexpensive.

The invention also provides an electricity production assembly including a fuel cell associated with a pipe in accordance with the invention.

Other characteristics and advantages of the invention appear from reading the following description of particular non-limiting embodiments of the invention.

### BRIEF DESCRIPTION OF THE DRAWING

Reference is made to the sole accompanying FIGURE, which is a diagrammatic representation of an electricity production assembly in accordance with the invention.

### DETAILED DESCRIPTION OF THE INVENTION

With reference to the FIGURE, the electricity production assembly comprises a fuel cell 1 connected to a hydrogen delivery unit 2 by a pipe 3. The fuel cell is of structure that it itself known, and it is not described in detail herein. The hydrogen distribution unit 2 may be a hydrogen tank or a device for producing hydrogen. By way of example, the electricity production assembly is designed to be mounted on board a self-propelled vehicle in order to power one or more electric motors.

Two embodiments of the pipe 3 are described below, together with variants thereof.

The pipe in accordance with the first embodiment comprises an inner layer of fluoropolymer, an intermediate layer of ethylene vinyl alcohol (EVOH), and an outer layer of polyphthalamide or polyphthalate (PPA).

The fluoropolymer may be ethylene tetrafluoroethylene (ETFE) or ethylene fluoroethylene perfluoride (EFEP).

The pipe is made by extrusion. The materials used present good mutual adhesion properties. Nevertheless, when these adhesion properties are insufficient, given the utilization conditions of the pipe, it is possible to add a bonding layer between the inner layer and the intermediate layer and/or between the intermediate layer and the outer layer.

The pipe in accordance with the second embodiment comprises an inner layer of polyamide, a first intermediate layer of fluoropolymer, a second intermediate layer of ethylene vinyl alcohol (EVOH), a third intermediate layer of polyamide, and an outer layer of polyphthalamide or polyphthalate (PPA).

The first intermediate layer may be made of ethylene tetrafluoroethylene (ETFE) or of ethylene fluoroethylene perfluoride (EFEP).

The pipe is made by extrusion and the materials used present mutual adhesion properties. Nevertheless, if these adhesion properties are insufficient, given the utilization conditions of the pipe, it is possible to add a layer of binder between the first intermediate layer and the second intermediate layer. In contrast, polyamide presents excellent adhesion properties with fluoropolymer, ethylene vinyl alcohol, and polyphthalamide, such that a layer of binder is optional between the inner layer and the first intermediate layer, between the second intermediate layer and the third intermediate layer, and between the third intermediate layer and the outer layer.

In a variant, the pipe may have a single layer of polyamide, either as its inner layer or as its third intermediate layer.

Naturally, the invention is not limited to the embodiments described and embodiment variants may be applied thereto without going beyond the ambit of the invention as defined by the claims.

For example, the fuel cell may be associated with more than one pipe in accordance with the invention.

The pipe of the invention may include layers in addition to those described, and it is possible to envisage using other fluoropolymers.

The pipe of the invention may be used for conveying fuels other than hydrogen and hydrocarbons.

What is claimed is:

1. A pipe comprising, from the inside towards the outside: a layer of fluoropolymer; an intermediate layer of ethylene and vinyl alcohol copolymer; and an outer layer of polyphthalamide.

2. The pipe according to claim 1, wherein the fluoropolymer is of ethylene tetrafluoroethylene (ETFE).

3. The pipe according to claim 1, wherein the fluoropolymer is an ethylene fluoroethylene perfluoride (EFEP).

4. The pipe according to claim 1, wherein the layer of fluoropolymer is the innermost layer of the pipe.

5. The pipe according to claim 1, having an inner layer of polyamide.

6. The pipe according to claim 5, wherein the layer of fluoropolymer is in contact with the inner layer and the intermediate layer.

7. The pipe according to claim 5, including a layer of polyamide extending between the layer of ethylene and vinyl alcohol copolymer and the outer layer.

8. An electricity production assembly comprising a fuel cell connected to a hydrogen delivery unit by a pipe comprising, from the inside towards the outside: a layer of fluoropolymer; an intermediate layer of ethylene and vinyl alcohol copolymer; and an outer layer of polyphthalamide.
